(19) United States
(12) Patent Application Publication
(10) Pub. No.: US 2004/0206396 A1
(43) Pub. Date: Oct. 21, 2004

(54) Valve, use of said valve, system comprising said valve and method for determining the condition of said system

(76) Inventor: Peter Behrends, Bobbau (DE)

Correspondence Address: Choate Hall & Stewart, Exchange Place, 53 State Street, Boston, MA, 02109-2891, US

(21) Appl. No.: 10/482,096

(22) PCT Filed: Jul. 18, 2003
(86) PCT No.: PCT/EP03/07885

(30) Foreign Application Priority Data
Jul. 24, 2002 (DE) 102 33 680.6

(51) Int. Cl. G05D 7/01

(52) U.S. Cl. 137/112

(57) ABSTRACT

The invention relates to an An automatically opening and closing value [[(1)]] for fluids, in which a connecting duct is opened or closed by means of a piston [[(7)]] displaceable axially by the fluid pressure. The invention can be used in refrigerating and/or pressure-medium engineering.

The present invention can be used in the field of systems acted upon by fluids, for example systems in refrigerating engineering or pressure generation or distribution systems.

The invention relates to a valve for a fluid for opening and closing a connecting duct between a first volume, in which a first pressure prevails, and a second volume, in which a second pressure prevails.

When fluids arranged in vessels or volumes are being dealt with, valves are used for the filling and emptying of vessels and for the connection or separation of vessels or volumes connected by means of conduits. German patent specification DE 19800854 discloses, for example, a check fitting for measuring, checking and evaluating physical parameters of circulated pressure media and/or refrigerants in the form of gas and/or in the form of liquid gas. The check fitting is inserted, for example, into a refrigerating engineering system and serves for measuring the pressure of a fluid located in the system, for example nitrogen, a condensation or evaporation temperature of the fluid being determined from the prevailing pressure by means of a computing device.

By means of a check fitting of this type, inter alia, the measuring device for measuring the pressure is also to be capable of being separated from the fluid-filled system, so that, for example, the pressure-measuring device can be removed or calibrated or so that the pressure-measuring device can be protected from too high a fluid pressure occurring in the system.

The check fitting known from the prior art can be actuated solely by hand, that is to say connections between various junctions have to be opened or closed manually by a fitter by the actuation of the valves.

The object on which the present invention is based is to simplify the operation of corresponding valves, to make it easier to maintain systems equipped with a valve of this type and to increase operating reliability.

The object is achieved, according to the invention, in a valve of the type mentioned in the introduction, with a piston which is guided in a hollow cylinder and the first end of which is acted upon by the first pressure and which is displaceable in its axial direction, counter to a counterforce, as a function of the first pressure, the connecting duct running from the first end of the piston into the wall of the hollow cylinder and being capable of being closed in a first direction, during a displacement of the piston, by virtue of the first pressure, in order to separate the first volume from the second volume.

The valve according to the invention has a connecting duct which can be automatically opened and closed as a function of the pressure prevailing in the first volume. The valve can thus be used in such a way that the first volume is connected at the second volume under specific pressure conditions only. In a system, the valve can be used in such a way that it automatically controls the connection between the first volume and the second volume in such a way that, for example, instruments arranged in the second volume or connected to the second volume are uncoupled from the first volume in the event of too high a pressure prevailing in the first volume, so that the instruments cannot be damaged by excess pressure.

This is achieved in that, by means of a high pressure prevailing in the first volume and acting on the first end of the piston, the piston is displaced in the axial direction, counter to the counterforce, until the connecting duct between the first volume and the second volume is closed.

This property of the valve may be utilized in a system, for example, in that the first volume is connected permanently to a first pressure-measuring instrument which is suitable for the measurement of higher pressures. The first volume may additionally be connected via the connecting duct to a second pressure-measuring instrument which is more sensitive than the first pressure-measuring instrument, but has to be protected from pressures which are too high.

If the pressure in the first volume remains below a threshold value, both pressure-measuring instruments indicate the measured pressure in the first volume, since the first volume is connected to the second volume via the connecting duct and therefore the same pressure prevails in the second volume as in the first volume.

If the pressure value in the first volume exceeds a threshold value, the connecting duct is closed as a result of the axial displacement of the piston and the second volume is separated from the first volume. The second pressure-measuring instrument will continue to indicate the pressure prevailing in the second volume, which, however, then no longer necessarily corresponds to the pressure prevailing in the first volume. The first pressure-measuring instrument will continue to correctly measure and indicate the pressure prevailing in the first volume.

In this way, by means of the valve according to the invention, a measurement of the pressure in the first volume can be carried out by means of a plurality of measuring instruments of staggered accuracy.

In an advantageous embodiment of the invention, the piston has at its first end a closed cover part, with the connecting duct open the latter runs through between the cover part and a sealing surface, facing the latter, of the hollow cylinder, and, in the event of the displacement of the piston in the first direction, the connecting duct can be closed by the cover part being placed on the sealing surface of the hollow cylinder.

The design described ensures that the connecting duct is closed as a result of the displacement of the piston by means of a defined minimum pressure in the first volume, and that, until the pressure falls again, the cover part is pressed against the sealing surface and the duct is thus kept closed. The sealing surface at the hollow cylinder is in each case designed continuously and extends transversely to the axial direction, so as to face or face away from the first volume.

An inverted design of the valve may also be envisaged, in which the connecting duct is opened as a result of the axial displacement of the piston only above a defined pressure prevailing in the first volume and is closed again when a pressure threshold value is undershot.

In a further advantageous embodiment of the invention, the piston is sealed off at the wall of the hollow cylinder by means of a displaceable seal which, as seen from the first end of the piston, lies axially on the far side of the point at which the connecting duct penetrates into the wall of the hollow cylinder.

By a displaceable seal being provided, in addition to effective sealing-off, a defined resistance is generated counter to the displacement of the piston in the hollow cylinder by means of sliding friction. The result of this is that a displacement of the piston occurs only when a defined resultant minimum force acts on the latter. This minimum force is composed as a resultant of all the forces acting on the piston, that is to say of the force acting by means of the first pressure and of the counterforce. Increased friction by means of an elastomeric seal results in a movement of the piston taking place only when the resultant force on the piston reaches a defined minimum value. This prevents the piston from being moved continuously by a small amount in the event of a change in the first pressure. Only significant changes in the pressure in the first volume then lead to a displacement of the piston which leads to a closing or opening of the connecting duct.

The invention may advantageously also be embodied in that a second end of the piston, the said end being opposite the first end, delimits a third volume and is acted upon by a third pressure, and in that the counterforce is generated at least partially by the third pressure.

By virtue of this design, it becomes possible to control the valve as a function of a differential pressure between the first and the third pressure, since the force and counterforce which act on the piston are generated by the first and the third pressure.

The control of the valve as a function of a pressure difference has the advantage, as compared with control by means of a force accumulator, for example a spring, that the prevailing forces are not influenced by variations on the apparatus, for example material ageing.

There may advantageously be provision for the piston (7) to have at its first end (10) and at its second end cross sections which are of equal size or are of different size in the manner of a differential piston.

By a differential piston being used, a defined pressure ratio can be set, at which the axial displacement of the piston and therefore the actuation of the valve take place. The valve can consequently be adapted to the intended use. The pressure ratios at which the valve opens or closes automatically are then dependent on the ratio of the various cross sections of the differential piston.

Further, the invention may advantageously be embodied in that the counterforce is generated at least partially by a spring.

There may be provision, further, for the piston to have inside it a pressure-relief valve which connects the first volume to the third volume in the event that the first pressure or the differential pressure between the first and the third pressure overshoots a defined threshold.

In this case, the valve ensures, independently of the closing or opening of the first connecting duct, that, above a defined pressure difference or a defined pressure ratio between the first and/or the second pressure, on the one hand, and the third pressure, on the other hand, pressure equalization takes place via the pressure-relief valve.

Since the pressure-relief valve may be designed in such a way that it responds very rapidly, this, too, may serve for protecting an instrument connected to the second volume, in the event that the pressure rises very rapidly, for example, in the first volume and an axial displacement of the piston for closing the connecting duct does not take place sufficiently quickly to uncouple the pressure-measuring instrument from the first volume. In this case, a rapid triggering of the pressure-relief valve ensures the lowering of the pressure in the first and/or the second volume, so that the pressure in the second volume can also be reduced even before the closing of the connecting duct. This may advantageously be achieved, in design terms, in that the pressure-relief valve has a closing disc which is pressed against a seal by means of a spring force and can be lifted off by excess pressure and which is acted upon on its first side by the first pressure and on its second side by the third pressure.

The invention relates, moreover, to the use of a valve according to the invention in a system capable of being acted upon by a fluid, in particular a refrigerating engineering system, with a pressure-measuring instrument connected to the first and/or the second volume and intended for determining the pressure of the fluid and, in particular, with a device for determining the condensation temperature or evaporation temperature of the fluid from the measured pressure.

Particularly in such a use of the valve, the advantages of the automatic opening and closing of the connecting duct may be utilized for protecting a connected pressure-measuring instrument.

For this purpose, the valve may also be used, for example, in the case of a transportable pressure-measuring instrument which, in the monitoring of refrigerating systems, is connected to one of these. The first volume of the valve is then connected, for example, to the cooling circuit of the system, in order to measure the pressure there. If this pressure is too high for the pressure-measuring instrument connected to the second volume, the valve closes automatically, so that the pressure-measuring instrument is protected, and the fitter can use another pressure-measuring instrument which is designed for the higher pressure prevailing in the system.

The invention relates, further, to a system, in particular refrigerating engineering system, with a valve according to one of Patent claims 1 to 10, with one or more pressure-measuring instruments connected to the first and/or the second volume and with a computing device for determining the condensation temperature or evaporation temperature of the fluid from the measured value of the pressure and from parameters of the fluid which are stored in a storage device.

In a system of this type equipped with the valve according to the invention, the pressure-measuring instrument can measure the pressure continuously or cyclically, so that in each case the condensation or the evaporation temperature of the fluid can be determined correspondingly. The corresponding measurement values can be stored continuously, without maintenance personnel having to be present, since, in the event of a rise of the pressure above a predetermined threshold or a fall below a predetermined threshold, the measuring device is automatically separated from the system by means of the valve.

A system of this kind may be implemented, for example, in that the first volume is connected to a high-pressure side or to a low-pressure side of the system.

Such a system may be used, for example, for the drying of volumes, a slight pressure which lies below the vapour pressure of the liquid to be dried being generated by evacuation. In order to check this, the condensation or the evaporation temperature at the measured pressure is to be checked and compared with the actual temperature. A corresponding method for determining the state of a system acted upon by a fluid by means of a valve according to the invention provides correspondingly for the system to be connected to the first volume of a valve according to one of Patent claims 1 to 10, for a pressure-measuring instrument to be connected to the second volume, for a check to be made as to whether the connecting duct is open and for the pressure then to be measured.

Moreover, in this case, there may be provision for the condensation or evaporation temperature of the fluid to be determined from the measured pressure value by means of a computing device. A microcontroller is typically used in this case.

The invention is shown below, with reference to an exemplary embodiment, in a drawing and is subsequently described.

In the drawing:

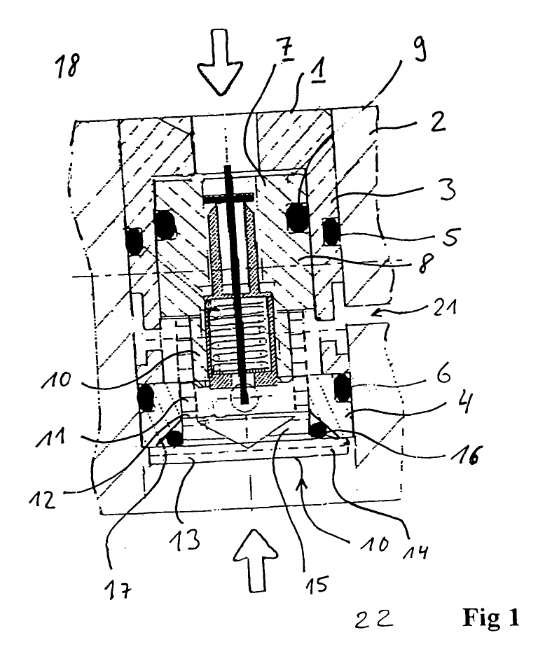

FIG. 1 shows diagrammatically, in cross section, a valve according to the invention in the closed state,

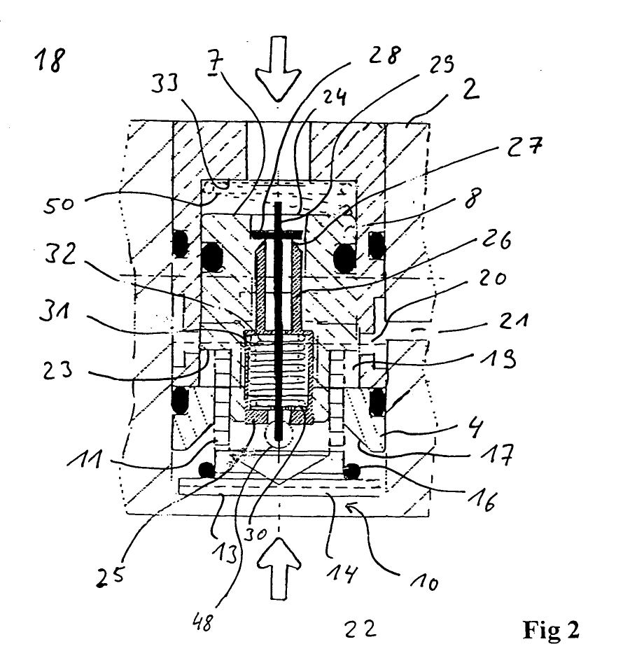

FIG. 2 shows a corresponding valve in the open state,

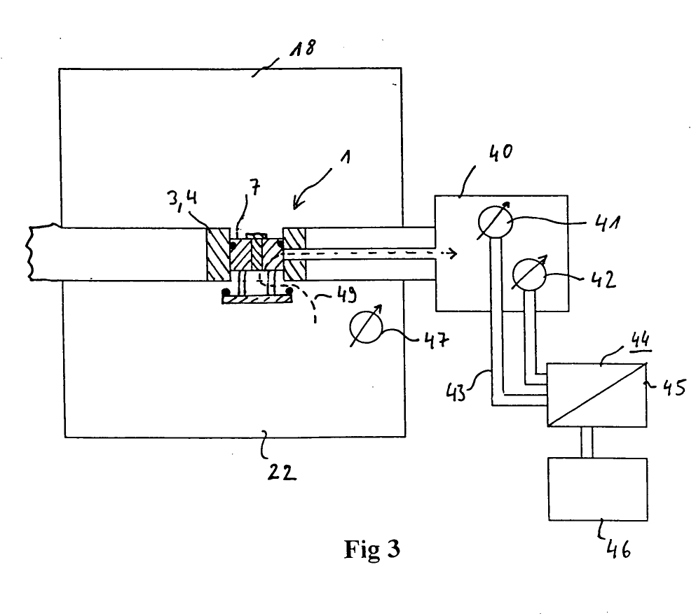

FIG. 3 shows diagrammatically a system with a valve according to the invention.

FIG. 1 shows a valve according to the invention diagrammatically in section. The valve 1 is inserted into a vessel wall 2 which separates various gas or fluid volumes from one another. The valve has a hollow cylinder 3, 4 which consists of a first hollow-cylinder part 3 and of a second hollow-cylinder part 4 adjoining the latter axially. The first hollow-cylinder part 3 is sealed off with respect to the housing wall 2 by means of a first seal 5 which is designed as a peripheral elastomer seal.

The second hollow-cylinder part 4 is sealed off with respect to the housing wall 2 by means of a second seal 6 likewise of peripheral design.

The hollow cylinder 3, 4 is inserted fixedly into the housing wall 2.

A piston 7 is arranged displaceably in the axial direction within the hollow cylinder 3, 4. The piston 7 has a first piston part 8, 10 which is adapted essentially to the cylindrical wall of the first hollow-cylinder part 3 and which is sealed off, gas-tight, with respect to the inner wall of the first hollow-cylinder part 3 by means of a displaceable seal 9 which is designed as an elastomeric seal. Conventional elastomers or elastomer-containing plastics come under consideration as materials for the displaceable seal 9. In order to make it easier for the piston 7 to be displaced axially with respect to the hollow cylinder 3, 4, there may be provision for the third seal 9 to slide on the inner wall of the hollow cylinder 3, 4 by means of a lubricant.

The first piston part is mechanically guided closely within the hollow cylinder or the first hollow-cylinder part 3.

The first piston part 8 has, at its end facing the first end 10 of the piston 7, a spring guide 10 which has an outside diameter reduced with respect to the remaining parts of the piston part 8.

Placed onto this spring guide 10 is a spring 11 which carries at its end 12 a cover part 13 of the piston 7.

The cover part 13 forms, together with the spring 11, a second piston part which is fixedly connected to the first piston part 8, 10.

The cover part 13 consists of a plate 14 which overlaps the edge of the second hollow-cylinder part 4. The plate 14 carries a disc 15, to which the spring 11 is fastened. The disc 15 has a smaller outside diameter than the plate 14. Located on the outer circumference of the disc 15 is a third seal 16 of round cross section which is designed as an elastomeric seal and is seated tautly on the disc 15 so that it is secured there.

When the plate 14 moves onto the edge of the second hollow-cylinder part 4, the said edge facing the first volume 22 and running around on the end face, the third seal 16 comes to bear on a conical sealing surface 17 at the edge of the second hollow-cylinder part 4. The third seal 16 then seals off, gas-tight, the interspace between the plate 14 and the second hollow-cylinder part 4, so that, in this state, the volume 22 located at the first end 10 of the piston 7 is separated by means of the valve 1 from the gas space (second volume) illustrated by the reference symbol 21.

FIG. 2 illustrates the valve in the open state. In this state, the piston 7 is displaced towards its first end 10. The third seal 16 is lifted off from the sealing surface 17, so that, between the second piston part 11, 13 and the second hollow-cylinder part 4, an interspace occurs, through which a fluid, for example gas or liquid gas, can flow out of the first volume 22, which faces the first end 10 of the piston 7, along the then open connecting duct and into the interior of the valve. The fluid can flow through the connecting duct along the open helical spring 11 further on as far as the cavity 19 and from there through the bore 20 in the first hollow-cylinder part 3 to the bore 21 in the housing wall 2. The bore 21 may have connected to it, by means of a junction, a second volume in which a measuring instrument, for example a pressure-measuring instrument, is located.

In the open valve position, as is illustrated in FIG. 2, the first volume is then connected, on the underside of the housing wall 2, to the volume connected to the bore 21, so that, by means of a pressure-measuring instrument located there, the pressure prevailing in the first volume 22 can be measured.

This open position of the connecting duct, which, starting from the first volume 22, extends between the third seal 16 and the second hollow-cylinder part 4 into the interior of the second piston part 11, 13 and leads from there via the volume 19 and the bore 20 to the bore 21, presupposes that, as illustrated in FIG. 2, the piston is displaced axially towards its first end 10.

The position of the piston 7 in relation to the hollow cylinder 3, 4 is dependent on the pressure ratios in the first volume, which is illustrated by the reference symbol 22, and in the third volume, which is illustrated by the reference symbol 18. The pressure in the first volume 22 acts on the first end 10 of the piston, that is to say, ultimately, on the end faces of the spring guide 10 of the first piston part and on the shoulder 23 of the first piston part. In addition to this, there is the end face of the pressure-relief valve 25, as long as this is closed.

The pressure prevailing in the third volume 18 acts on the other end of the piston 7, specifically on the end face 24 arranged there. The forces acting as a result of these possibly different pressures in the volumes 22, 18 lead to the piston 7 being displaced either towards the first volume 22 or towards the third volume 18 and to the valve therefore opening or closing automatically. When the valve is closed, the third seal 16 lies on the sealing surface 17 of the second hollow-cylinder part 4 and the pressure in the volume 22 acting on the plate 14 keeps the piston in its position.

To assist the force acting on the end face 24 of the piston 7, a helical spring may be provided between the piston 7 and the shoulder 33 of the first hollow-cylinder part 3.

When the valve is in its open position and a sudden and pronounced pressure rise occurs, the valve may possibly not react sufficiently quickly as a result of the displacement of the piston 7 and may prevent the occurrence of excess pressure at the bore 21 or at the corresponding junction to the second volume. In this case, the pressure-relief valve 25 comes into action, which is arranged in a central bore of the first piston part 8. The pressure-relief valve 25 has a tubular part 26 which, at its end facing the third volume 18, has a sealing surface 27 on which a sealing disc 28 lies. The sealing disc 28 is connected by means of a guide rod 29 to a control disc 30 which is displaceable axially in a spring cylinder 31. In this case, the control disc 30 is pressed in the direction of the first volume 22 by a control spring 32 guided in the spring cylinder 31. By means of this force, the sealing disc 28 is pressed against the sealing surface 27, so that the pressure-relief valve is normally closed.

A pronounced pressure rise in the first volume 22 has the result that the fluid can flow past the guide rod 29 into the spring cylinder 31 and further on into the guide tube 26 towards the sealing disc 28 and can lift off the latter from the sealing surface 27 counter to the force of the spring 32. The fluid can then flow out from there into the third volume 18.

After the reduction of the pressure in the first volume 22, the control disc 30 is pressed back again by the spring 32 and consequently the sealing disc 28 is also pressed onto the seal 27, so that, in this state, the pressure-relief valve 25 closes again.

The length of the piston 7 is such that, as is evident in FIG. 1, the latter does not bear on the shoulder 33 of the first hollow-cylinder part 3 even in the closed state of the valve 1, so that, there, the pressure prevailing in the third volume 18 can act on the entire end face 24 of the piston. Any tolerances are compensated by the axial compressibility of the piston 7 in the region of the spring 11.

Instead of the spring 11, a tubular part may also be used, which, however, then has bores 48 which allow the fluid flowing in between the third seal 16 and the sealing surface 17 to pass through to the bores 20, 21, on the one hand, and to the pressure-relief valve 25, on the other hand.

FIG. 3 shows, in an illustration simplified even further diagrammatically in relation to FIGS. 1 and 2, the use of the valve 1 according to the invention in a system, for example a refrigerating system. The first volume 22 corresponds to the high-pressure part or the low-pressure part of the system, whilst the second volume 18 corresponds to another gas space, for example the atmosphere. The valve 1 with its axially displaceable piston 7 is arranged between these parts.

In the open state of the valve 1, the connecting duct 49, which is illustrated by broken lines in FIG. 3, is open between the first volume 22 and the second volume 40. The pressure-measuring instrument 41 then measures the pressure prevailing in the second volume 40 and first volume 22. Moreover, a temperature-measuring instrument 42 may also be provided in the second volume 40. The measurement valves of the measuring instruments are conducted via measuring lines 43 to a computing device 44 which determines a condensation or evaporation temperature from the measured pressure with the aid of reference values filed in a storage device 45. This temperature is indicated by means of an indicator unit 46 and can be compared with the measured temperature which can likewise be indicated.

The computing unit 44 can determine the condensation or evaporation temperature either on the basis of known formulas (general gas equation), taking into account the constants of the gas/fluid present in each case, or by virtue of stored value lists/approximation curves by interpolation. In addition, a further measuring device 47 may be arranged directly in the first volume 22, the further pressure-measuring device 47 being designed to be less sensitive, but more resistant to high pressure than the pressure-measuring instrument 41. If an excessively high pressure is then established in the first volume 22, the valve 1 closes automatically and the second volume 40 is separated from the first volume 22, so that the first pressure-measuring instrument 41 can no longer be used for measuring the pressure in the first volume 22. In this case, the pressure can continue to be measured at a less accurate level by means of the second pressure-measuring instrument 47.

1. Valve for a fluid for opening and closing a connecting duct between a first volume, in which a first pressure prevails, and a second volume, in which a second pressure prevails, comprising:
a piston which is guided in a hollow cylinder and the first end of which is acted upon by the first pressure and which is displaceable in its axial direction, counter to a counterforce, as a function of the first pressure, the connecting duct running from the first end of the piston into a wall of the hollow cylinder and being capable of being closed in a first direction, during a displacement of the piston, by virtue of the first pressure, in order to separate the first volume from the second volume.

2. The valve according to claim 1, wherein the piston has at its first end a closed cover part and wherein, with the connecting duct open, the latter runs between the cover part and a sealing surface, facing the latter, of the hollow cylinder, and wherein, in the event of the displacement of the piston in the first direction, the connecting duct can be closed by the cover part being placed on the sealing surface of the hollow cylinder.

3. The valve according to claim 1, wherein the piston is sealed off at the wall of the hollow cylinder by means of a displaceable seal which, as seen from the first end of the piston, lies axially on the far side of the point at which the connecting duct penetrates into the wall of the hollow cylinder.

4. The valve according to claim 3, wherein the displaceable seal generates, between the piston and the hollow cylinder, a defined frictional force which has to be overcome in order to displace the piston.

5. The valve according to claim 1, wherein a second end of the piston, the second end being opposite the first end, delimits a third volume and is acted upon by a third pressure prevailing in the third volume, and wherein the counterforce is generated at least partially by the third pressure.

6. The valve according to claim 5, wherein the piston has at its first end and at its second end cross sections which are of equal size.

7. The valve according to claim 1 wherein the counterforce is generated at least partially by a spring.

8. The valve according to claim 5 wherein the piston has inside it a pressure-relief valve which connects the first volume to the third volume in the event that the first pressure or the differential pressure between the first and the third pressure overshoots a defined threshold.

9. The valve according to claim 8, wherein the pressure-relief valve has a closing disc which is pressed against a seal by means of a spring force and can be lifted off by excess pressure and which is acted upon on its first side by the first pressure and on its second side by the third pressure.

10. The valve according to claim 1 wherein a measuring instrument, is connected to the second volume.

11. A method of using a valve in a system capable of being acted upon by a fluid, for opening and closing a connecting duct between a first volume, in which a first pressure prevails, and a second volume, in which a second pressure prevails, comprising:
connecting a pressure-measuring instrument to the first and/or the second volume;
measuring a pressure of the fluid; and
determining the condensation temperature or evaporation temperature of the fluid from the measured pressure;
wherein the valve includes a piston which is guided in a hollow cylinder and the first end of which is acted upon by the first pressure and which is displaceable in its axial direction, counter to a counterforce, as a function of the first pressure, the connecting duct running from the first end of the piston into a wall of the hollow cylinder and being capable of being closed in a first direction, during a displacement of the piston, by virtue of the first pressure, in order to separate the first volume from the second volume.

12. A system with a valve for a fluid for opening and closing a connecting duct between a first volume, in which a first pressure prevails, and a second volume, in which a second pressure prevails, the system comprising:
one or more pressure-measuring instruments connected to at least one of the first and the second volume; and
a computing device for determining the condensation temperature or evaporation temperature of the fluid from a measured value of the pressure and from parameters of the fluid which are stored in a storage device;
wherein the valve includes a piston which is guided in a hollow cylinder and the first end of which is acted upon by the first pressure and which is displaceable in its axial direction, counter to a counterforce, as a function of the first pressure, the connecting duct running from the first end of the piston into a wall of the hollow cylinder and being capable of being closed in a first direction, during a displacement of the piston, by virtue of the first pressure, in order to separate the first volume from the second volume.

13. The system according to claim 12, wherein the first volume is connected to a high-pressure side of the system.

14. A method for determining the state of a system acted upon by a fluid, comprising:
connecting the system to a first volume of a valve for a fluid for opening and closing a connecting duct between the first volume, in which a first pressure prevails, and a second volume, in which a second pressure prevails;
connecting a pressure measuring instrument to the second volume;
checking as to whether the connecting duct is open; and
measuring the pressure to generate a measured pressure value;
wherein the valve includes a piston which is guided in a hollow cylinder and the first end of which is acted upon by the first pressure and which is displaceable in its axial direction, counter to a counterforce, as a function of the first pressure, the connecting duct running from the first end of the piston into a wall of the hollow cylinder and being capable of being closed in a first direction, during a displacement of the piston, by virtue of the first pressure, in order to separate the first volume from the second volume.

15. The method according to claim 14, further including: determining the condensation temperature or evaporation temperature of the fluid from the measured pressure value by means of a computing device.

16. The valve according to claim 5, wherein the piston has at its first end and at its second end cross sections which are of a different size in the manner of a differential piston.

17. The system according to claim 12, wherein the first volume is connected to a low-pressure side of the system.

18. A valve, comprising:
a hollow cylinder having a first opening in an end thereof and having a second opening in a sidewall thereof; and
a piston disposed in said hollow cylinder and being axially displaceable therein, said piston being acted upon by a first pressure provided through said first opening and being acted upon by a counterforce to said first pressure, wherein said piston prevents a flow of fluid between the first and second openings in said hollow cylinder in response to said first pressure exceeding a predetermined value.

19. The valve according to claim 18, wherein said first pressure acts upon a first axial end of said piston and said counterforce acts upon a second opposing axial end of said piston.

20. The valve according to claim 18, wherein said first and second openings are a part of a fluid conduit that runs through said hollow cylinder.

21. The valve according to claim 18, wherein the piston includes a closed cover part positioned at the first end of the piston, and wherein upon displacement of the piston, a flow of fluid between said first and second openings is prevented by engagement of the cover part with a surface of the hollow cylinder.

22. The valve according to claim 18, wherein the piston is sealed off at the wall of the hollow cylinder by means of a displaceable seal which lies axially on the far side of the area at which said second opening penetrates into the sidewall of the hollow cylinder.

23. The valve according to claim 22, wherein the displaceable seal generates a defined frictional force between the piston and the hollow cylinder that opposes displacement of the piston.

24. The valve according to claim 18, wherein a second end of the piston, the second end being axially opposite the first end, delimits a volume and is acted upon by a counterforce pressure prevailing in the volume, and wherein said counterforce is generated at least partially by the counterforce pressure.

25. The valve according to claim 24, wherein the piston has at its first end and at its second end cross sections which are of equal size.

26. The valve according to claim 24, wherein the piston has at its first end and at its second end cross sections which are of a different size in the manner of a differential piston.

27. The valve according to claim 18, wherein the counterforce is generated at least partially by a spring connected to said piston.

28. The valve according to claim 24, wherein the piston includes a pressure-relief valve which connects a first volume having said first pressure to said volume having said counterforce pressure when the first pressure exceeds a predetermined threshold.

29. The valve according to claim 28, wherein the pressure-relief valve includes a closing disc which is pressed against a seal by means of a spring force and can be lifted off by excess pressure and which is acted upon on its first side by the first pressure and on its second side by the counterforce pressure.

30. A valve system, comprising:
a hollow cylinder having a first opening in an end thereof and having a second opening in a wall thereof; and
a piston disposed in said hollow cylinder and being axially displaceable therein, said piston being acted upon by a first pressure provided through said first opening and being acted upon by a counterforce to said first pressure, wherein said piston prevents a flow of fluid between the first and second opening in said hollow cylinder in response to said first pressure exceeding a predetermined value; and
at least one pressure-measuring instrument exposed to at least one of said first pressure and a second pressure provided through said second opening and which generates at least one measured pressure value.

31. The system according to claim 30, further comprising a computing device that determines the condensation temperature or evaporation temperature of the fluid from said at least one measured pressure value.

32. A method of separating a first volume and a second volume, comprising:
providing a hollow cylinder having a first opening in an end thereof and having a second opening in a sidewall thereof, said first opening exposed to said first volume and said second opening exposed to said second volume;
providing a piston disposed in said hollow cylinder and being axially displaceable therein, said piston being acted upon by a first pressure provided through said first opening and being acted upon by a counterforce to said first pressure; and
preventing flow of fluid between said first opening and said second opening during a displacement of the piston when said first pressure exceeds a predetermined value.
